(19) United States
(12) Patent Application Publication
(10) Pub. No.: US 2017/0260964 A1
(43) Pub. Date: Sep. 14, 2017

(54) WIND TURBINE DEVICE

(71) Applicant: Kuo-Chang HUANG, Tainan City (TW)

(72) Inventor: Kuo-Chang HUANG, Tainan City (TW)

(21) Appl. No.: 15/456,142

(22) Filed: Mar. 10, 2017

(30) Foreign Application Priority Data
Mar. 11, 2016 (TW) 105107512

(51) Int. Cl. F03D 3/06; F03D 3/00

(52) U.S. Cl. CPC F03D 3/061; F03D 3/002

(57) ABSTRACT

A wind turbine device includes a rotatable seat, and a blade assembly including a rotary shaft having a fulcrum portion rotatably connected to the rotatable seat, and two mounting portions extending oppositely and respectively from two opposite ends of the fulcrum portion. At least two blade units are respectively connected to the mounting portions. Each blade unit includes a plurality of angularly spaced-apart blade modules each including a grid frame and a plurality of blades connected to the grid frame. The grid frame includes at least two airfoil-shaped first rods extending along an axial direction of the rotary shaft and spaced apart from each other along a radial direction of the rotary shaft.

### CROSS-REFERENCE TO RELATED APPLICATION

This application claims priority of Taiwanese Patent Application No. 105107512, filed on Mar. 11, 2016.

### FIELD

The disclosure relates to a wind turbine device that can be applied to a power generation equipment.

### BACKGROUND

Referring to FIG. 1, a wind turbine blade device, as disclosed in Taiwanese Patent No. M485960, includes a rotary shaft 81 and a plurality of angularly spaced-apart blade modules 82. Each blade module 82 includes a grid frame 821 connected to the rotary shaft 81, and a plurality of blades 822 movably connected to the grid frame 821. In use, the rotary shaft 81 may be connected to a rotatable seat (not shown) of a wind turbine, and a rudder (not shown) may be connected to the rotatable seat. When the wind blows along a flow direction, the rudder is pushed by the wind to drive rotation of the rotatable seat, which in turn drives the wind turbine blade device to rotate such that the blade modules 82 are transverse to the flow direction of the wind and directly face the wind. However, because the blade modules 82 are acted upon by the wind and drive rotation of the rotatable seat, the wind turbine blade device instead is driven to rotate such that the blade modules 82 are parallel to the flow direction of the wind.

From the foregoing, it is apparent that the rotatable seat is acted upon by the rudder and the blade modules 82 to rotate in opposite directions, so that the rudder must have a size corresponding to that of the blade module 82 so as to provide a sufficient rotational force to retain the blade modules 82 at a wind position. If the size of each blade module 82 is increased so as to increase the torque, the size of the rudder must also be increased. The material cost of the wind turbine is thus increased.

### SUMMARY

Therefore, an object of the present disclosure is to provide a wind turbine device having a reduced material cost.

Accordingly, a wind turbine device of this disclosure includes a rotatable seat rotatable about a vertical axis, and a blade assembly mounted on and rotatable along with the rotatable seat. The blade assembly includes a rotary shaft and at least two blade units. The rotary shaft extends along a horizontal axis transverse to the vertical axis and has a fulcrum portion at the center thereof and rotatably connected to the rotatable seat, and two mounting portions extending oppositely and respectively from two opposite ends of the fulcrum portion along the horizontal axis. The at least two blade units are respectively connected to the mounting portions of the rotary shaft. Each blade unit includes a plurality of angularly spaced-apart blade modules surrounding the horizontal axis. Each blade module includes a grid frame connected to a corresponding one of the mounting portions, and a plurality of blades connected to the grid frame. The grid frame includes at least two airfoil-shaped first rods extending along an axial direction of the rotary shaft and spaced apart from each other along a radial direction of the rotary shaft.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a wind turbine blade device disclosed in Taiwanese Patent No. M485960;

FIG. 2 is a perspective view of a wind turbine device according to the embodiment of the present disclosure;

FIG. 3 is an enlarged fragmentary partly sectional view of a blade module of the embodiment located on an upper side of a rotary shaft of FIG. 1;

FIG. 4 is a partly sectional schematic side view of a blade unit of the embodiment, illustrating how blades of blade modules of the blade unit are positioned when pushed by the wind flowing along a flow direction;

FIG. 5 is an enlarged fragmentary schematic view of FIG. 4;

FIG. 6 is a fragmentary perspective view of the embodiment with the blade module located on the upper side of the rotary shaft being removed for the sake of clarity;

FIG. 7 is a schematic top view, illustrating the embodiment facing the flow direction of the wind; and

FIG. 8 is a schematic top view, illustrating a blade assembly of the embodiment being rotated in the direction of an arrow (A) from an imaginary-line position to a solid-line position by another flow direction of the wind.

### DETAILED DESCRIPTION

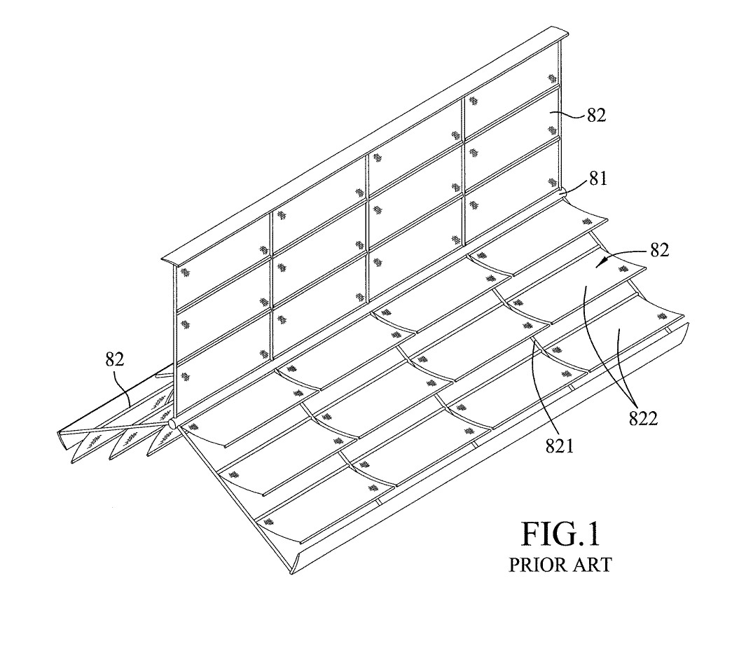

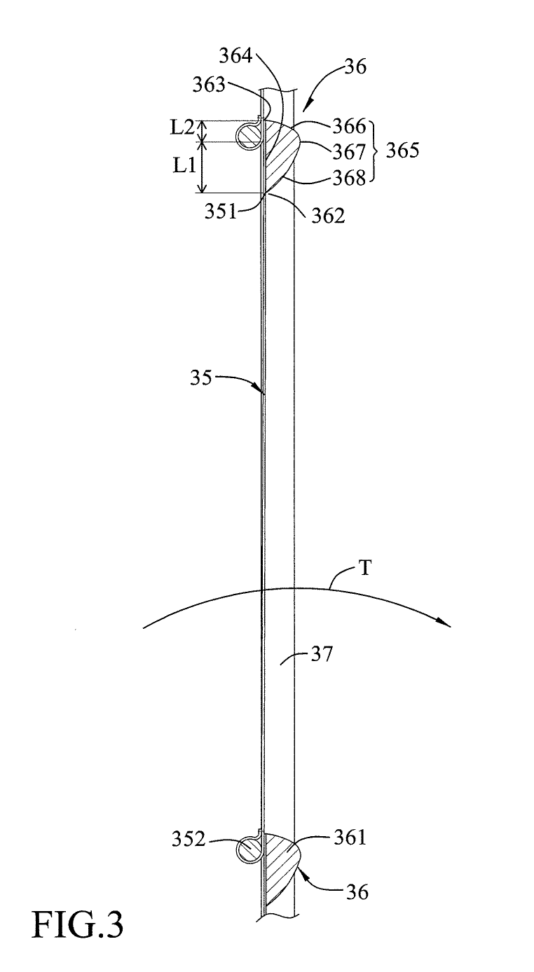

Referring to FIGS. 1 to 8, a wind turbine device 100 according to the embodiment of the present disclosure is shown to comprise a rotatable seat 1, a rudder assembly 2, and a blade assembly 3.

The rotatable seat 1 is supported on top of amounting device 9 which is fixed to the ground. The rotatable seat 1 is pivoted to the mounting device 9 such that it can rotate relative to the mounting device 9 about a vertical axis (V) which is perpendicular to the ground.

The rudder assembly 2 includes a rudder support arm 21 fixed to and extending outwardly and horizontally from the rotatable seat 1, and a rudder 22 disposed on one end of the rudder support arm 21 which is distal from the rotatable seat 1. The rudder 22 is configured to be pushed by the wind to generate a rotating force (R) that drives rotation of the rotatable seat 1 about the vertical axis (V).

The blade assembly 3 is mounted on and rotatable along with the rotatable seat 1, and is configured to be driven by the wind to rotate in a rotating direction (T). The blade assembly 3 includes a rotary shaft 31 extending along a horizontal axis (H) transverse to the vertical axis (V), and two blade units 32 connected to the rotary shaft 31.

The rotary shaft 31 of this embodiment is an elongated hollow rod, and has a fulcrum portion 311 at the center thereof and rotatably connected to the rotatable seat 1, and two mounting portions 312 extending oppositely and respectively from two opposite sides of the fulcrum portion 311 along the horizontal axis (H). The mounting portions 312 are elastically bendable relative to the fulcrum portion 311. Since this embodiment is applicable to medium-and large-scale power generation equipments, the length of the rotary shaft 31 is relatively long, even up to tens to hundreds of meters. Generally, the rotary shaft 31 may be made of a metal material, but not limited thereto.

Each blade unit 32 is connected to a respective one of the mounting portions 312, and includes a plurality of angularly spaced-apart blade modules 33 surrounding the horizontal axis (H). Each blade module 33 extends substantially in a radial direction of the rotary shaft 31, and includes a grid frame 34 connected to a corresponding one of the mounting portions 312, and a plurality of blades 35 connected to the grid frame 34. In this embodiment, the number of the blade module 33 is three, and the grid frames 34 of the blade modules 33 are spaced apart from each other by an angle of 120 degrees. However, in actual practice, the number of the blade module 33 may be two, four or more than five. Further, the number of the blade unit 32 may be four, six, or other even numbers, and are symmetrically disposed on the mounting portions 312. The number of the blade unit 32 is not limited to the aforesaid disclosure.

Each grid frame 34 includes a plurality of airfoil-shaped first rods 36 extending along an axial direction of the rotary shaft 31 and spaced apart from each other along the radial direction of the rotary shaft 31, and a plurality of second rods 37 extending along the radial direction of the rotary shaft 31 and spaced apart from each other along the axial direction of the rotary shaft 31. The first and second rods 36, 37 intersect each other and cooperate with each other to define a plurality of spaces 38 arranged in matrix.

Each airfoil-shaped first rod 36 has a cross section that includes an inner end 362 and an outer end 363 spaced apart from each other along the radial direction of the rotary shaft 31, a straight side 364 extending from the inner end 362 to the outer end 363 in a straight line, and a curved side 365 extending from the inner end 362 to the outer end 363 in a curved line and protruding toward the rotating direction (T). The curved side 365 has an outer curved section 366 extending gradually and curvedly from the outer end 363 to a turning point 367, and an inner curved section 368 extending gradually and curvedly from the turning point 367 to the inner end 362. The turning point 367 is distal from the straight side 364. The inner curved section 368 has a length (L1) extending along the radial direction longer than the length (L2) of the outer curved section 366.

The blades 35 respectively correspond to the spaces 38. Each blade 35 has a connecting end 351 connected to a corresponding one of the first rods 36 which is distal from the rotary shaft 31, and a free end 352 opposite to the connecting end 351 and proximate to the rotary shaft 31. Each blade 35 is movable relative the grid frame 34 between a closed position, in which the blade 35 covers the respective space 38 and the free end 352 thereof abuts against an adjacent first rod 36 which is proximate to the rotary shaft 31, and an open position, in which the free end 352 of the blade 35 is moved away from the adjacent first rod 36 to expose the respective space 38.

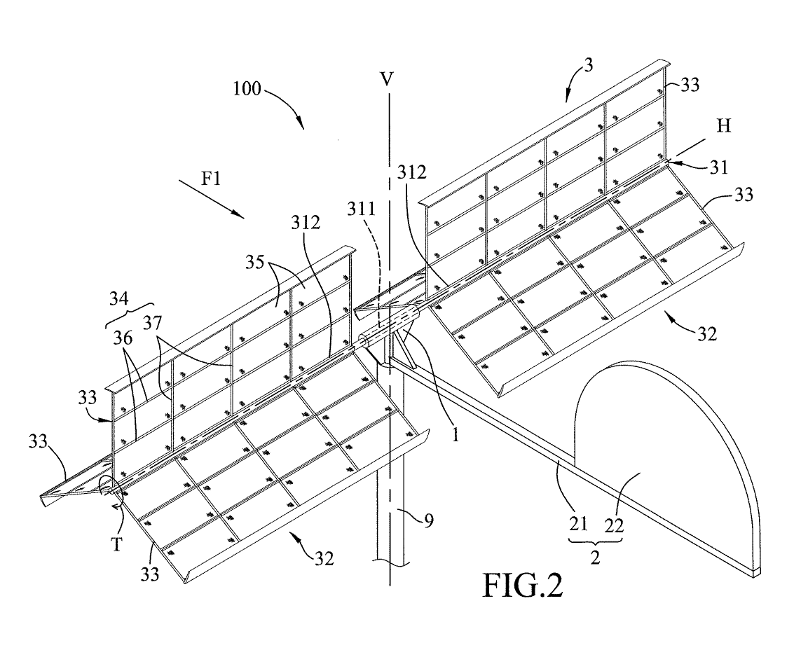

Since the structures of the two blade units 32 connected to the respective mounting portions 312 of the rotary shaft 31 are identical, only one of the blade units 32 will be described hereinafter. With reference to FIGS. 2, 4 and 5, in use, the two blade modules 33 located on a lower side of the rotary shaft 31 are positioned on an upwind side of the wind turbine device 100, while the blade module 33 located on an upper side the rotary shaft 31 is positioned on a downwind side of the wind turbine device 100. When the upper blade module 33 is pushed by the wind flowing along a flow direction (F1), the blades 35 thereof are blown to abut against the grid frame 34 so as to place the blades 35 in the closed position that cover the respective spaces 38. The blades 35 of the upper blade module 33 cooperatively define an upwind surface of the upper blade module 33. When the free ends 352 of the blades 35 of the two lower blade modules 33 are pushed by the wind, they are moved away from the corresponding adjacent first rods 36 which are proximate to the rotary shaft 31 to place the blades 35 of the lower blade modules 33 in the open position and to expose the respective spaces 38, so that the wind can flow through the spaces 38 of the lower blade modules 33. Through the cooperation of the open and closed positions of the blades 35 of the blade modules 33, a high rotational torque can be produced, so that the blade modules 33 of the blade units 32 together with the rotary shaft 31 can be rotated in the rotating direction (T).

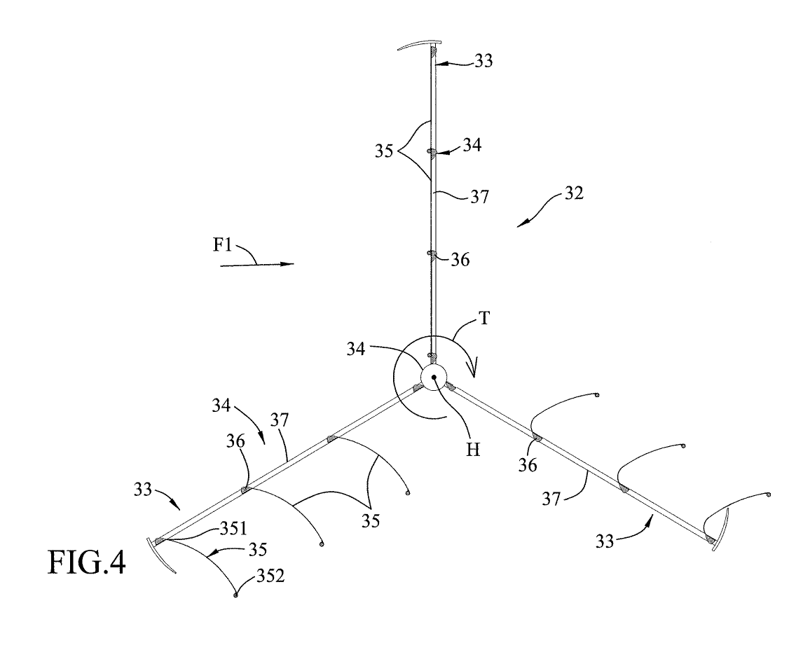

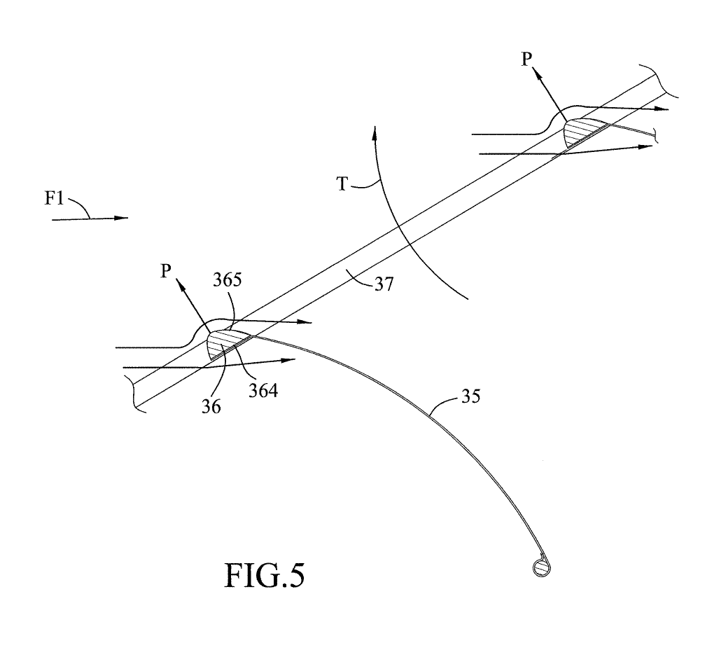

It should be noted herein that when the wind moves past the airfoil-shaped first rods 36 of the blade module which is located at a specific position, the airfoil-shaped first rods 36 can generate deflection forces (P) deflecting a corresponding one of the mounting portions 312 of the rotary shaft 31 to move in a direction opposite to the flow direction (F1). With reference to FIGS. 4 and 5, when the blades 35 of the blade module 33 located at a lower left position are blown by the wind to move to the open position, through the structural design of the airfoil-shaped first rods 36, the wind moving past the curved sides 365 of the airfoil-shaped first rods 36 is allow to flow faster, and the wind moving past the straight side 364 of the airfoil-shaped first rod 36 is allow to flow slower. According to Bernoulli's principle, as the speed of the wind increases, the pressure thereof decreases. Hence, the airfoil-shaped first rods 36 can generate deflection forces (P) opposite to the flow direction (F1).

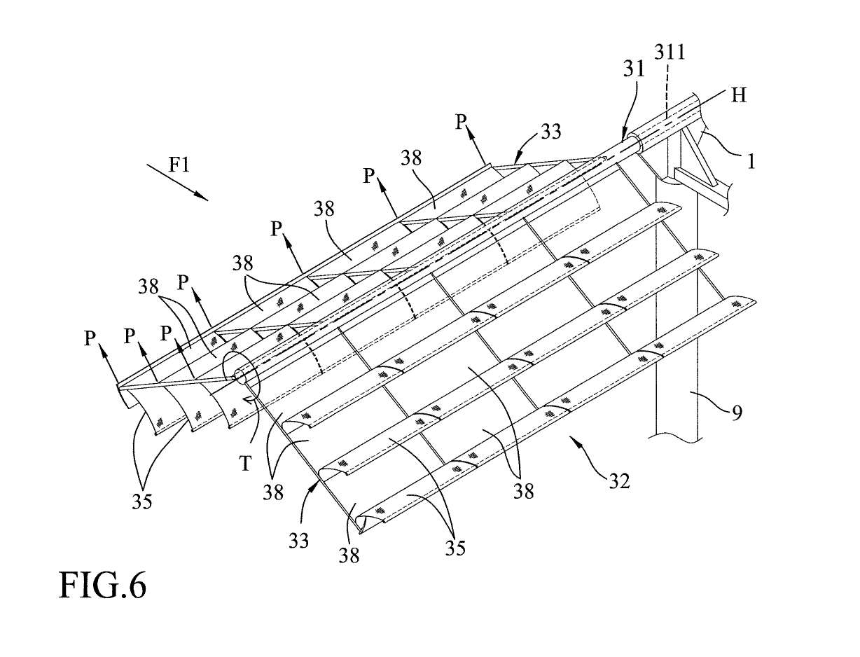

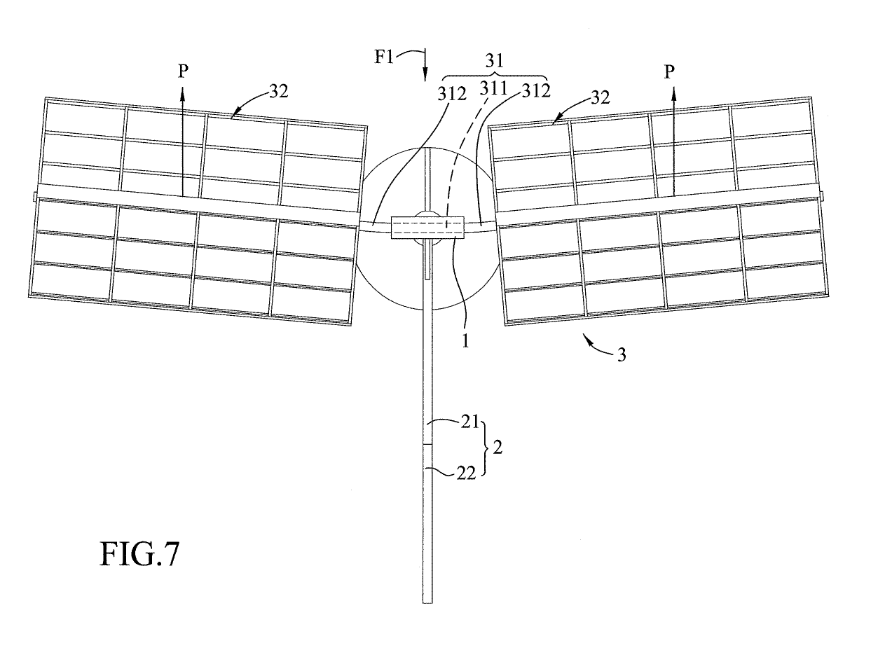

With reference to FIGS. 6 and 7, when the airfoil-shaped first rods 36 of the two lower blade modules 33 of the blade units 32 generate the deflection forces (P), they will drive the mounting portions 312 of the rotary shaft 31 to flex relative to the fulcrum portion 311 in the direction opposite to the flow direction (F1), so that the rotary shaft 31 is curved and the blade units 32 are stably maintained in a wind position.

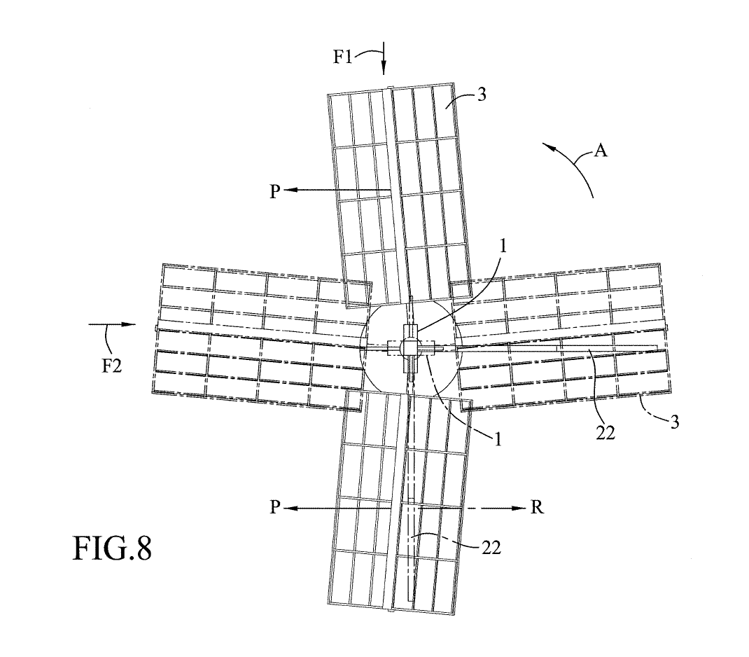

With reference to FIG. 8, when the direction of the wind is changed from the flow direction (F1) to the flow direction (F2), the rudder 22 is pushed by the wind, and generates a rotating force (R) that drives rotation of the rotatable seat 1 which in turn drives the blade assembly 3 to rotate to the wind position. The blade assembly 3 is rotated in the direction of an arrow (A) from an imaginary-line position to a solid-line position. Following the rotation of the blade assembly 3, the blade modules 33 have an increased contact area with the wind, and are subjected to a resistance force opposite to the rotating force (R). The airfoil-shaped first rods 36 of each lower blade module 33 also have an increased contact area with the wind, and generate deflection forces (P) opposite to the flow direction (F2). The rotating force (R) is assisted by the deflection forces (P) to overcome the resistance force caused by the wind so as to rotate the rotatable seat 1 which in turn drives the blade assembly 3 to rotate to the wind position, as shown in solid lines in FIG. 8.

Additionally, in this embodiment, the number of the airfoil-shaped first rod 36 of the grid frame 34 of each blade module 33 is four. In actual practice, the number of the airfoil-shaped first rod 36 may be two, five, etc., and is not limited to the aforesaid disclosure.

In sum, through the structural design of the airfoil-shaped first rods 36, when the wind moves past the airfoil-shaped first rods 36, the first rods 36 can generate deflection forces (P) opposite to the flow direction (F1). Through this, the rotating force (R) provided by the rudder 22 can be reduced. Further, through the coordination of the rotating force (R) and the deflection forces (P), the blade assembly 3 can be rotated to the wind position. As such, the size of the rudder 22 can be minimized to save the material cost of the wind turbine device 100 of this disclosure.

Moreover, the lengths of the airfoil-shaped first rods 36 may be adjusted according to the size of the blade module 33. Thus, when the size of the blade module 33 is increased to enhance the torque, the lengths of the airfoil-shaped first rods 36 are also increased to provide greater deflection forces to assist the rotating force of the rudder 22. As such, the material cost required to increase the size of the rudder 22 can be reduced. The object of the wind turbine device 100 of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A wind turbine device, comprising:
a rotatable seat rotatable about a vertical axis; and
a blade assembly mounted on and rotatable along with said rotatable seat, said blade assembly including
a rotary shaft extending along a horizontal axis transverse to the vertical axis and having a fulcrum portion at the center thereof and rotatably connected to said rotatable seat, and two mounting portions extending oppositely and respectively from two opposite ends of said fulcrum portion along the horizontal axis, and
at least two blade units respectively connected to said mounting portions of said rotary shaft, each of said at least two blade units including a plurality of angularly spaced-apart blade modules surrounding the horizontal axis, each of said blade modules including a grid frame connected to a corresponding one of said mounting portions, and a plurality of blades connected to said grid frame, said grid frame including at least two airfoil-shaped first rods extending along an axial direction of said rotary shaft and spaced apart from each other along a radial direction of said rotary shaft.

2. The wind turbine device as claimed in claim 1, wherein each of said at least two airfoil-shaped first rods has a cross section that includes an inner end and an outer end spaced apart from each other along the radial direction of said rotary shaft, a straight side extending from said inner end to said outer end in a straight line, and a curved side extending from said inner end to said outer end in a curved line.

3. The wind turbine device as claimed in claim 2, wherein said curved side has an outer curved section extending gradually and curvedly from said outer end to a turning point, and an inner curved section extending gradually and curvedly from said turning point to said inner end, said turning point being distal from said straight side, said inner curved section having a length (L1) extending along the radial direction of said rotary shaft longer than the length (L2) of said outer curved section.

4. The wind turbine device as claimed in claim 3, further comprising a rudder assembly which includes a rudder support arm fixed to and extending outwardly and horizontally from said rotatable seat, and a rudder disposed on one end of said rudder support arm which is distal from said rotatable seat, said rudder being configured to be pushed by the wind to generate a rotating force that drives rotation of said rotatable seat which in turn drives said blade assembly to rotate to a wind position.

5. The wind turbine device as claimed in claim 1, wherein said grid frame further includes a plurality of spaces arranged in matrix, said blades respectively corresponding to said spaces, each of said blades having a connecting end connected to one of said at least two airfoil-shaped first rods which is distal from said rotary shaft, and a free end opposite to said connecting end and proximate to said rotary shaft, each of said blades being movable relative to said grid frame between a closed position, in which said blade covers a respective one of said spaces and said free end thereof abuts against one of said at least two airfoil-shaped first rods which is proximate to said rotary shaft, and an open position, in which said free end of said blade is moved away from said one of said at least two airfoil-shaped first rods which is proximate to said rotary shaft to expose the respective one of said spaces.

6. The wind turbine device as claimed in claim 5, wherein said at least two airfoil-shaped first rods includes a plurality of airfoil-shaped first rods spaced apart from each other along the radial direction of said rotary shaft, said grid frame further including a plurality of second rods extending along the radial direction of said rotary shaft and spaced apart from each other along the axial direction of said rotary shaft, said airfoil-shaped first rods and said second rods intersecting each other and cooperating with each other to define said spaces.
